(19) United States
(12) Patent Application Publication
(10) Pub. No.: US 2011/0131887 A1
(43) Pub. Date: Jun. 9, 2011

(54) Weatherseal Having Flexible Projection

(76) Inventors: Joseph Henry, Mooresville, NC (US); John E. Huntress, Brentwood, NH (US)

(21) Appl. No.: 12/959,954

(22) Filed: Dec. 3, 2010

Related U.S. Application Data
(60) Provisional application No. 61/266,238, filed on Dec. 3, 2009.

(51) Int. Cl. E06B 7/22; E06B 7/16

(52) U.S. Cl. 49/493.1; 49/506

(57) ABSTRACT

A weatherseal includes a T-shaped base having a first edge, a second opposing edge, and an intermediate portion between the first edge and the second opposing edge. A substantially continuous projection is secured to and projects from at least one of the first edge and the second opposing edge. A sealing element extends from the intermediate portion. Methods for manufacturing the weatherseal include extruding a substantially continuous projection onto at least one of the first edge and the second opposing edge. The weatherseal may be inserted into a frame member defining a substantially T-shaped slot. Methods for inserting the weatherseal include inserting the first edge into the T-shaped slot at an angle through a throat opening, and forcing the second opposing edge into the T-shaped slot through the throat opening.

### CROSS-REFERENCE TO RELATED APPLICATIONS

This application claims priority to and the benefit of U.S. Provisional Patent Application Ser. No. 61/266,238, filed on Dec. 3, 2009, the disclosure of which is hereby incorporated by reference in its entirety.

### FIELD OF THE INVENTION

The present invention relates generally to weatherseals and, more specifically, to weatherseals for architectural doors and windows.

### BACKGROUND OF THE INVENTION

T-slots have been used for many years to attach weatherseals to windows and doors. A T-slot provides a pocket for receiving a substantially T-shaped base or backing of a weatherseal, which includes a sealing member that extends from the backing, out of the slot, and into the gap to be sealed. To achieve the desired performance, the weatherseal should be easy to insert into the slot and, once inserted, should remain in place and provide a proper seal. Too often, however, the T-slot has dimensions that deviate from nominal or target values (e.g., industry standards) to the extent that a conventional weatherseal may not be inserted easily and/or may not remain in the desired position within the slot. For example, a throat opening of the slot may be too narrow for the weatherstrip to be fully inserted. In other instances, once the weatherseal is inserted, one or more portions of the seal may move within the slot to create undesirable gaps, thereby allowing air, water, and/or other undesirable materials to infiltrate around the seal. In addition, T-slots that are too large may provide inadequate friction between the seal and the slot, and this may cause “pull-back,” which occurs when the seal is cut under tension and the seal then relaxes to a length that is shorter than the slot.

Unfortunately, it can be difficult and/or expensive to provide T-slots that always have dimensions within industry standards. For example, to achieve the desired dimensions, door frames or window frames may need to be reworked and/or scrapped. In addition, the dies used in extrusion processes to manufacture the T-slots may require expensive refurbishment and/or replacement at greater frequency. As a result, it has been difficult for manufacturers to produce T-slots that consistently meet industry standards.

For the above reasons, there is a need for weatherseals that perform well with T-slots that do not meet industry standards. Improvement is needed, for example, to allow seals to be more easily inserted, to retain the seals in the proper position, and to prevent the infiltration of air, water, and/or other materials between the seal and the slot.

### SUMMARY OF THE INVENTION

In one aspect, the invention relates to a weatherseal that includes a T-shaped base having a first edge, a second opposing edge, and an intermediate portion between the first edge and the second opposing edge. The weatherseal also includes a substantially continuous projection secured to and projecting from at least one of the first edge and the second opposing edge. The weatherseal further includes a sealing element extending from the intermediate portion.

In an embodiment of the above aspect, the weatherseal includes at least one of a pile material, a foam profile, and a hollow bulb. In another embodiment, the substantially continuous projection is secured to and projects from each of the first edge and the second opposing edge. In a further embodiment, the base includes a material having a first stiffness and the projection includes a material having a second stiffness that is less than the first stiffness. In other embodiments, the substantially continuous projection includes a material having a Rockwell Shore A hardness less than about 80, or less than about 40. In another embodiment, the substantially continuous projection includes a thermoplastic elastomer, flexible polyvinyl chloride, and/or ethylene vinyl acetate. In certain embodiments, the base includes a material having a Rockwell Shore D hardness greater than about 20, or greater than about 60. In still another embodiment, the base includes polypropylene, rigid polyvinyl chloride, and/or acrylonitrile butadiene styrene.

In another aspect, the invention relates to a method for manufacturing a weatherseal that includes the step of providing a T-shaped base having a first edge, a second opposing edge, and an intermediate portion between the first edge and the second opposing edge. The method also includes the step of extruding a substantially continuous projection onto at least one of the first edge and the second opposing edge.

In an embodiment of the above aspect, the substantially continuous projection is secured to and projects from each of the first edge and the second opposing edge. In another embodiment, the method includes the step of providing a sealing element extending from the intermediate portion. In another embodiment, the sealing element is extruded onto the intermediate portion. In yet another embodiment, the base providing step includes extruding the base, and the projection extruding step includes co-extruding the projection with the base. In still another embodiment, the base includes a material having a first stiffness and the projection includes a material having a second stiffness that is less than the first stiffness.

In another aspect, the invention relates to a fenestration frame that includes a frame member defining a substantially T-shaped slot. The fenestration frame also includes a weatherseal. The weatherseal includes a T-shaped base having a first edge, a second opposing edge, and an intermediate portion between the first edge and the second opposing edge. The base is located substantially within the T-shaped slot. The weatherseal also includes a sealing element extending from the intermediate portion. The weatherseal further includes a substantially continuous projection secured to and projecting from at least one of the first edge and the second opposing edge.

In an embodiment of the above aspect, the weatherseal defines a weatherseal width. In another embodiment, the T-shaped slot includes a nominal width substantially equal to or less than the weatherseal width to promote a close fit or an interference fit. In another embodiment, the sealing element includes a sealing element width proximate the intermediate portion. In yet another embodiment, the T-shaped slot includes a throat width larger than the sealing element width. In still another embodiment, the substantially continuous projection is secured to and projects from the first edge and the second opposing edge.

In another aspect, the invention relates to a method for inserting a weatherseal into a frame member defining a substantially T-shaped slot with a throat opening. The method includes the step of providing a weatherseal. The weatherseal includes a T-shaped base having a first edge, a second opposing edge, and an intermediate portion between the first edge and the second opposing edge. The weatherseal also includes a sealing element extending from the intermediate portion. The weatherseal further includes a substantially continuous projection secured to and projecting from at least one of the first edge and the second opposing edge. The method also includes the step of inserting the first edge into the T-shaped slot at an angle through the throat opening. The method further includes the step of forcing the second opposing edge into the T-shaped slot through the throat opening. In an embodiment of the above aspect, the forcing step utilizes at least one of a roller and an insertion finger.

### DESCRIPTION OF THE DRAWINGS

Other features and advantages of the present invention, as well as the invention itself, can be more fully understood from the following description of the various embodiments, when read together with the accompanying drawings, in which:

FIG. 1 is a schematic perspective view of a frame, in accordance with an embodiment of the present invention;

FIG. 2a is an enlarged schematic perspective view of a portion of the frame of FIG. 1, in accordance with an embodiment of the present invention;

FIG. 2b is a front view of a weatherseal including a base and substantially continuous projections, in accordance with an embodiment of the present invention;

FIG. 3 is a flowchart depicting a method for inserting a weatherseal into a frame member of the frame, in accordance with an embodiment of the present invention;

FIGS. 4-6 are enlarged schematic front views of a weatherseal inserted in various T-shaped slots, in accordance with an embodiment of the present invention;

FIGS. 7-8 are schematic front views of weatherseals, in accordance with other embodiments of the present invention; and

FIG. 9 is a flowchart depicting a method for manufacturing a weatherseal, in accordance with an embodiment of the present invention.

### DETAILED DESCRIPTION

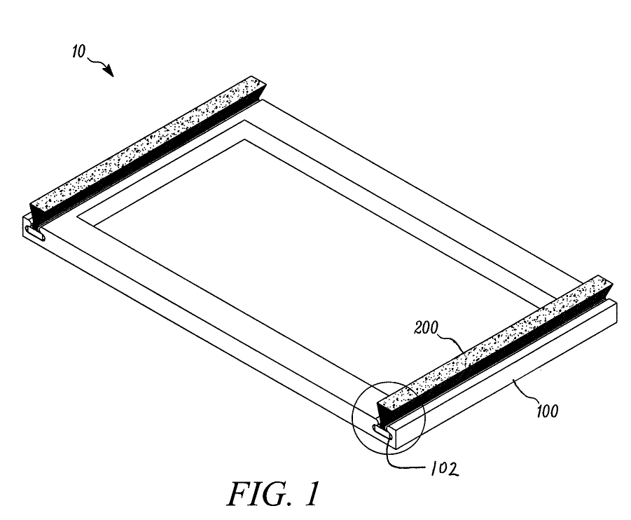

FIG. 1 depicts a schematic perspective view of a frame 10, in accordance with an embodiment of the present invention. The frame 10 includes a frame member 100 and a weatherseal 200. The frame 10 may be part of a window or door assembly and may be either a fixed portion attached to a building structure or a movable portion. In the depicted embodiment, the frame 10 is a window frame, but the frame 10 may also be any other type of frame, such as a door frame or any part of a door or window. The frame member 100 includes a substantially T-shaped slot 102, which may be formed by any suitable process, such as extrusion, injection molding, and/or machining. The weatherseal 200 is inserted within the T-shaped slot 102.

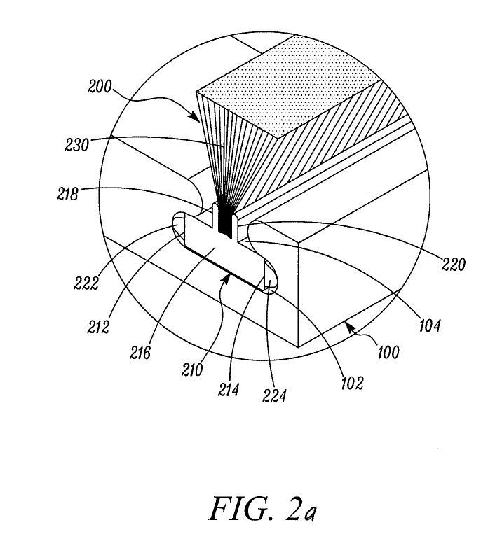

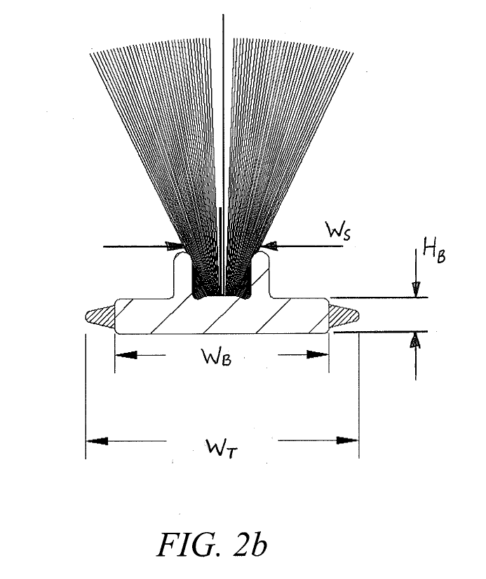

FIG. 2a is an enlarged perspective view of an encircled portion of the frame 10 of FIG. 1, including the weatherseal 200 inserted into the T-shaped slot 102. The weatherseal 200 includes a base 210, which is an elongated structure adapted to be received in the T-shaped slot 102 and typically has a matching T-shaped cross-section. The base 210 includes a first edge 212, a second opposing edge 214, and an intermediate portion 216 between the first edge 212 and the second opposing edge 214. The intermediate portion 216 includes a pair of wall members 218, 220 that are parallel and spaced apart from each other. In the depicted embodiment, the intermediate portion 216, the first edge 212, and the second opposing edge 214 define a substantially T-shaped base 210.

The weatherseal 200 also includes a first projection 222 and a second projection 224 (hereinafter referred to as projections 222, 224) secured to and projecting from the first edge 212 and the second opposing edge 214, respectively. The projections 222, 224 are substantially continuous and run along the length of the first edge 212 and the second opposing edge 214. Alternatively, the weatherseal 200 may include only a single projection, such as one of the projections 222, 224, secured to and projecting from one of the first edge 212 and the second opposing edge 214. To retain the weatherseal 200 in the T-shaped slot 102, a width of the T-shaped slot 102 is smaller than a width of the base 210 plus the one or more projections 222, 224. In addition, while the depicted projections 222, 224 have an approximately triangular cross-section, the projections 222, 224 may have any cross-sectional shape, such as circular, semi-circular, rectangular, and/or square.

The materials used for the base 210 and projections 222, 224 may be chosen so that the stiffness (e.g., Young's modulus) of the base 210 is greater than the stiffness of the projections 222, 224. The base 210 may be made of any sufficiently stiff and chemically resistant solid material, such as polypropylene, rigid polyvinyl chloride, and/or acrylonitrile butadiene styrene. For example, in one embodiment, the base 210 is made of polypropylene. Typical Rockwell Shore D hardness values for the base 210 are greater than about 20. For example, the Rockwell Shore D hardness for the base 210 may be greater than about 60. Similarly, the projections 222, 224 may be made of any suitable solid materials having the desired mechanical and chemical properties, such as thermoplastic elastomers, flexible polyvinyl chloride, and/or ethylene vinyl acetate. In one embodiment, the projections 222, 224 are made of thermoplastic elastomers. The projections 222, 224 may also be foamed. Typical Rockwell Shore A hardness values for the projections 222, 224 are less than about 80. For example, the Rockwell Shore A hardness for the projections 222, 224 may be less than about 40. It is apparent to a person of ordinary skill in the art that the materials of the base 210 and the projections 222, 224, mentioned above, are for exemplary purposes only and should not limit the scope of the present invention.

As depicted in FIG. 2a, the weatherseal 200 further includes a sealing element 230 extending from a space between the pair of wall members 218, 220. In one embodiment, the sealing element 230 includes a pile material, which may include, but is not limited to, a row of fibers or brush materials mounted between the pair of wall members 218, 220. The pile material is attached to the wall members 218, 220 using, for example, an adhesive, a resin, mechanical fasteners, and/or a thermal process, such as ultrasonic welding. When inserted in the T-shaped slot 102, the wall members 218, 220 and/or the sealing element pass through a throat opening 104 of the T-shaped slot 102.

Referring to FIG. 2b, the weatherseal 200 defines a base width W_{B}, a weatherseal width W_{T}, a base height H_{B}, and a sealing element width W_{S}. As depicted, the base width W_{B} is the width of the base 210, and the weatherseal width W_{T} is the distance between outer edges of the projections 222, 224 (i.e., the width of the base 210 plus the width of the projections 222, 224). To provide a close fit or an interference fit between the weatherseal 200 and the T-shaped slot 102, the weatherseal width W_{T} is chosen to be equal to or greater than a width of the bottom of the T-shaped slot 102. As depicted, the base height is the height of the base 210, and the sealing element width W_{S} is the width of the sealing element proximate the intermediate portion 216. To facilitate insertion of the weatherseal 200, and to provide a proper fit, the sealing element width W_{S} may be less than a width of the throat opening 104 of the T-shaped slot 102.

In certain embodiments, depending on the dimensions of the T-shaped slot, the weatherseal 200 may have the following dimensions: a base width W_{B} of about 0.180 inches, a weatherseal width W_{T} of about 0.230 inches, a base height H_{B} of about 0.030 inches, and a sealing element width W_{S} of about 0.065 inches. It is apparent to a person of ordinary skill in the art that the dimensions of the weatherseal 200 provided above are for exemplary purposes only and should not be considered limiting with regard to the present invention.

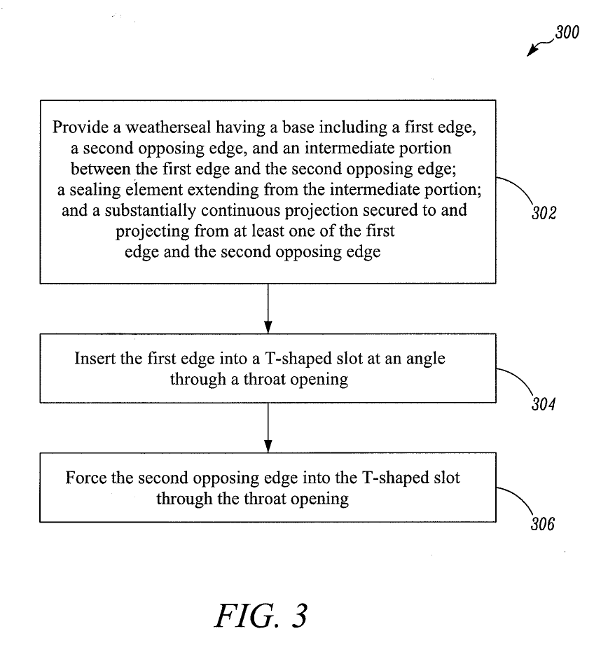

FIG. 3 is a flowchart of a method 300 for inserting the weatherseal 200 into the frame member 100, in accordance with an embodiment of the present invention. The method includes a step of providing (step 302) the weatherseal 200. The first edge 212 of the base 210 of the weatherseal 200 is inserted (step 304) into the T-shaped slot 102 of the frame member 100. Specifically, the first edge 212 and the projection 222 is inserted into the T-shaped slot 102 at an angle through the throat opening 104 of the T-shaped slot 102.

After the first edge 212 of the base 210 is inserted into the T-shaped slot 102, the second opposing edge 214 of the base 210 is forced (step 306) into the T-shaped slot 102 through the throat opening 104. A roller or an insertion finger may be utilized to elastically deform the base 210 and/or the projections 222, 224 to force the second opposing edge 214 into the T-shaped slot 102. Once fully in the slot 102, the base 210 springs back to its normal configuration. Accordingly, the width of the T-shaped slot 102 accommodates the base 210 and projections 222, 224 of the weatherseal 200, and the width of the throat opening 104 of the T-shaped slot 102 accommodates the sealing element 230 of the weatherseal 200. Further, the projections 222, 224 of the weatherseal 200 provide an interference fit within the T-shaped slot 102. Specifically, the projections 222, 224 may compress, deflect, bend, or twist within the T-shaped slot 102 to allow the base 210 to adjustably seal and fit within the width of the T-shaped slot 102. Further, the flexible or deformable nature of the projections 222, 224 provides friction or grip between the base 210 and the T-shaped slot 102 to minimize or prevent relative movement in use. For slots 102 that have one or both ends open, it may be possible to insert the base 210 longitudinally into the slot 102.

The dimensions and physical properties of the weatherseal 200 are optimized to facilitate insertion into and retention within the T-shaped slot 102. For example, the base 210 is rigid enough to be forced through the throat opening 104, yet flexible enough to deflect, as needed, during the insertion process. Similarly, the projections 222, 224 facilitate insertion into the slot 102 by deforming or compressing so that the base 210 may pass through the throat opening and reach the bottom of the slot 102. In addition, by providing an interference fit with the T-shaped slot 102, the projections 222, 224 generate sufficient friction to maintain the position of the weatherseal 200 within the T-shaped slot. This friction also minimizes pull-back so that the length of the weatherseal 200 does not change substantially after it has been cut to size under tension. Moreover, the interference fit seals the T-shaped slot 102 and thereby prevents air, water, and/or other materials from infiltrating around the base 210 within the slot 102.

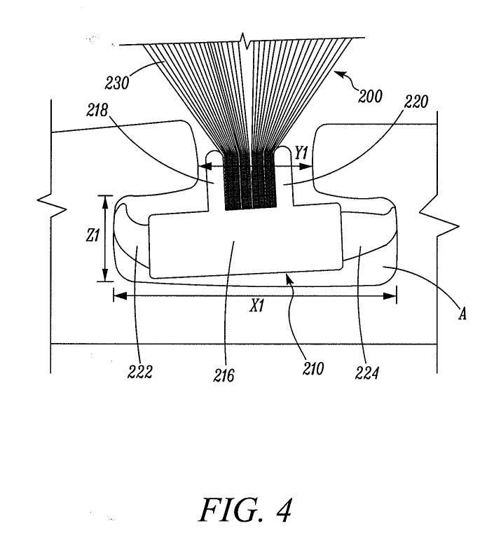

As depicted in FIGS. 4-6, the deformable nature of the projections 222, 224 also allows the weatherseal 200 to be used with T-shaped slots 102 that deviate from industry standards. According to the AAMA 701-702-04 industry standard, a T-shaped slot may have a width of about 0.210 inches, a throat opening width of about 0.125 inches, and a total depth of about 0.080 inches to about 0.110 inches. The total depth includes a height of the bottom of the T-shaped slot that is about 0.050 inches, and a height of the throat portion that is from about 0.030 inches to about 0.060 inches. Alternatively, according to the AAMA 701-702-04 industry standard, a T-shaped slot may have a width of about 0.310 inches, a throat opening width of about 0.180 inches, and a total depth of about 0.080 inches to about 0.110 inches.

Referring to FIG. 4, the weatherseal 200 (having dimensions as depicted in FIG. 2b) may be utilized in conjunction with a T-shaped slot ‘A’ having dimensions that deviate from industry standards. For example, the T-shaped slot ‘A’ may include the following dimensions: a width X1 of 0.215 inches, a throat opening width Y1 of 0.103 inches (considerably less than the industry standard throat opening of 0.125 inches), and a bottom height Z1 of 0.053 inches. The bottom height Z1 is the height of the bottom of the T-shaped slot ‘A.’ As depicted, although the dimensions of the T-shaped slot ‘A’ are beyond industry standards, the weatherseal 200 is capable of being inserted into the T-shaped slot ‘A’ and achieving an interference fit. Specifically, the rigid base 210 of the weatherseal 200 is narrow enough to fit through the narrow throat opening. In addition, the projections 222, 224 are able to deform or deflect, as needed, to span the entire width X1 so that the T-shaped slot ‘A’ is sealed and the weatherseal 200 is retained in position with sufficient friction.

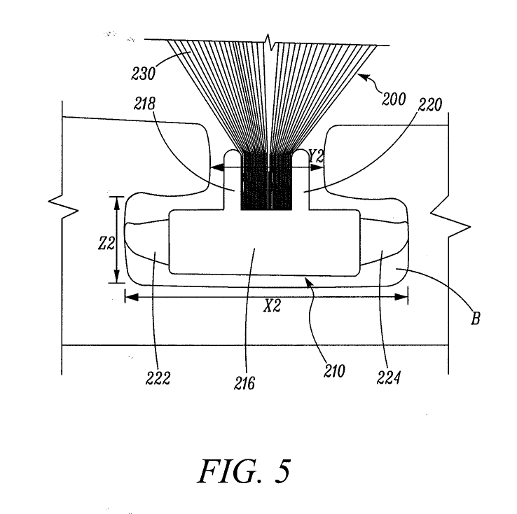

Referring to FIG. 5, the weatherseal 200 may be utilized in conjunction with a T-shaped slot ‘B’ having the following dimensions, which comply with industry standards: a width X2 of 0.219 inches, a throat opening width Y2 of 0.118 inches, and a bottom height Z2 of 0.059 inches. In this case, the deformable projections 222, 224 achieve the desired interference fit within the T-shaped slot ‘B.’ As depicted, friction forces between the weatherseal 200 and the T-shaped slot ‘B’ are generated where the projections 222, 224 contact the edges of the T-shaped slot ‘B.’ When T-shaped slots are produced by extrusion, it may be easier to maintain and control the slot width than the throat width and/or the bottom height.

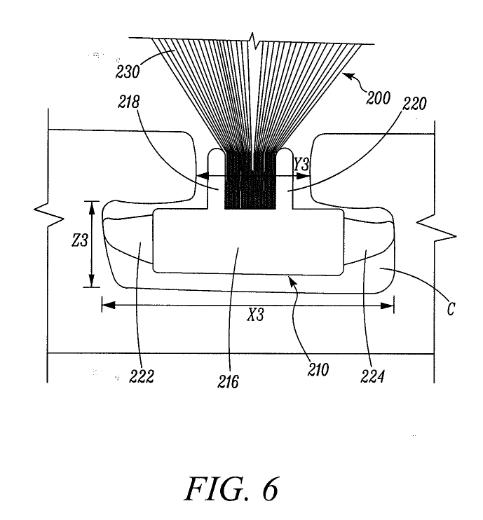

Referring to FIG. 6, the weatherseal 200 may be utilized in conjunction with a T-shaped slot ‘C’ having the following dimensions, which are larger than industry standards: a width X3 of 0.236 inches (considerably larger than the industry standard width of 0.210), a throat opening width Y3 of 0.135 inches, and a bottom height Z3 of 0.059 inches. In this case, the deformable projections 222, 224 are again able to achieve the desired interference fit with the T-shaped slot ‘C.’ In addition, despite the oversized throat opening width Y3, the interference fit generates sufficient friction so that the weatherseal 200 remains in position and may not be pulled readily out of the throat opening.

As discussed above and depicted in FIGS. 4-6, the weatherseal 200 is capable of being inserted into and achieving a desirable fit with T-shaped slots that have a wide range of dimensions, including dimensions that deviate from industry standards. In addition to enhancing weatherseal performance, this result has the added benefit of reducing the costs associated with the manufacturing of T-shaped slots. For example, manufacturers are able to sell and/or utilize products that they might otherwise need to refurbish and/or scrap. In addition, use of the weatherseal 200 prolongs the useful life of T-slot extrusion dies and reduces the frequency with which the dies need to be refurbished to meet specifications.

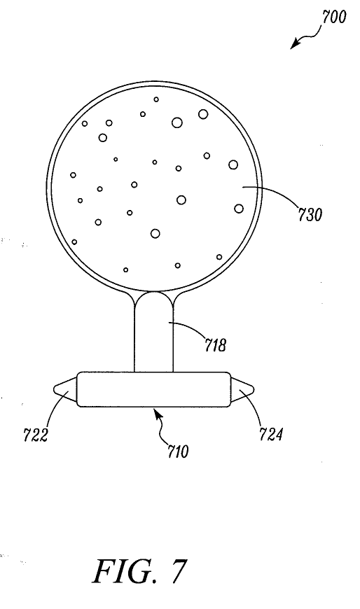

FIG. 7 is a front view of a weatherseal 700, in accordance with another embodiment of the present invention. The weatherseal 700 includes a base 710, a projecting tab 718, and a sealing member 730. As depicted, the sealing member 730 is attached to an outer edge of the projecting tab 718, which extends from the intermediate portion of the base 710. The sealing member 730 may be attached to the projecting tab 718 using, for example, a resin, an adhesive, mechanical fasteners, or any suitable method. In the depicted embodiment, the sealing element 730 includes a cylindrical foam material. In addition, the weatherseal 700 includes projections 722, 724 that extend from the outer edges of the base 710. The materials used for the base 710 and the projections 722, 724 are the same as those described above. Further, it is to be understood that the weatherseal 700 may include only a single projection (i.e., one of the projections 722, 724).

The weatherseal 700 is adapted to be used in conjunction with a frame member having a T-shaped slot, such as the frame member 100 and T-shaped slot 102, depicted in FIG. 2. As described above, the weatherseal 700 may also be used to provide the desired interference fit with T-shaped slots that deviate from industry standards, such as the T-shaped slot C, depicted in FIG. 6.

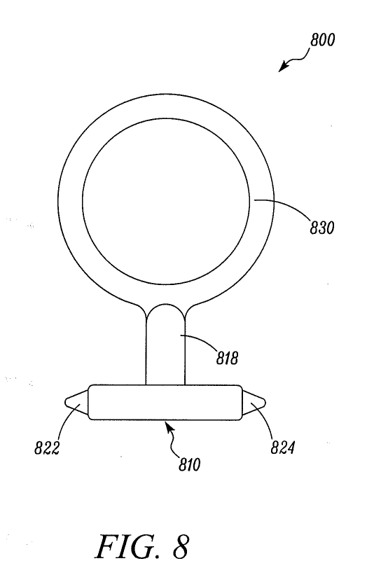

FIG. 8 illustrates a front view of a weatherseal 800, in accordance with another embodiment of the present invention. The weatherseal 800 includes a base 810 and a projecting tab 818 extending from an intermediate portion of the base 810. The outer edges of base 810 include projections 822, 824, similar to those described above. For example, the projections 822, 824 are made from one or more materials that are more easily deformed than the base 810. Further, it is to be understood that the weatherseal 800 may include only a single projection (i.e., one of the projections 822, 824).

The weatherseal 800 further includes a sealing member 830 mounted on the projecting tab 818 using, for example, a resin, an adhesive, mechanical fasteners, or any suitable method. In the depicted embodiment, the sealing element 830 is a hollow cylindrical bulb made of a flexible material, such as rubber. The weatherseal 800 is adapted to be used in conjunction with a frame member having a T-shaped slot, such as the frame member 100 and T-shaped slot 102 depicted in FIG. 2. The weatherseal 800 is also adapted to be used in T-shaped slots that deviate from industry standards, such as the T-shaped slots C depicted in FIG. 6.

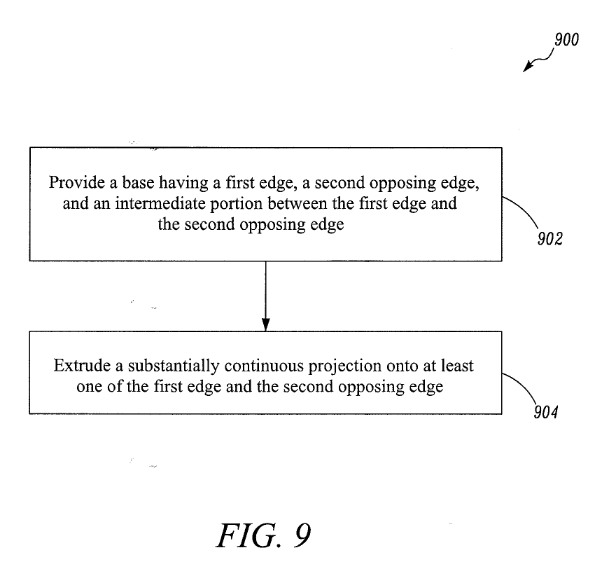

FIG. 9 is a flowchart depicting a method 900 for manufacturing a weatherseal, such as one or more of the weatherseals depicted in FIGS. 4-8. The method includes a step of providing (step 902) a base, such as the T-shaped base 210 depicted in FIG. 2. The base may be formed using any suitable process, such as extrusion, injection molding, and/or machining. As described above, the base includes a first edge, a second opposing edge, and an intermediate portion. The method also includes a step of extruding (step 904) a substantially continuous projection onto at least one of the first edge and the second opposing edge. In one embodiment, the substantially continuous projection is co-extruded with the base. For example, a projection may be co-extruded onto only one of the first edge and the second edge, or a projection may be co-extruded onto both the first edge and the second edge. In other embodiments, the projections may be solid strips that are adhered directly onto to the first edge and the second edge using, for example, an adhesive, a resin, or a thermal method, such as ultrasonic welding.

The method 900 may also include a step (not shown) of providing a sealing element that extends from an intermediate portion of the base. For example, the sealing element may be extruded onto the intermediate portion of the base. In other embodiments, the sealing element is attached using, for example, an adhesive, a resin, mechanical fasteners, or other suitable methods. Sealing elements, such as those depicted in FIGS. 2, 7 and 8, may be attached to the base using the methods described above.

While shown for use with T-shaped bases and related slots, it will be apparent that the benefits of the invention can be realized in various weatherseals having different base configurations.

The terms and expressions employed herein are used as terms and expressions of description and not of limitation, and there is no intention, in the use of such terms and expressions, of excluding any equivalents of the features shown and described or portions thereof. In addition, having described certain embodiments of the invention, it will be apparent to those of ordinary skill in the art that other embodiments incorporating the concepts disclosed herein may be used without departing from the spirit and scope of the invention. The features and functions of the various embodiments may be arranged in various combinations and permutations, and all are considered to be within the scope of the disclosed invention. Accordingly, the described embodiments are to be considered in all respects as only illustrative and not restrictive. Furthermore, the configurations described herein are intended as illustrative and in no way limiting. Similarly, although physical explanations have been provided for explanatory purposes, there is no intent to be bound by any particular theory or mechanism, or to limit the claims in accordance therewith.

What is claimed is:

1. A weatherseal comprising:
a T-shaped base comprising a first edge, a second opposing edge, and an intermediate portion between the first edge and the second opposing edge;
a substantially continuous projection secured to and projecting from at least one of the first edge and the second opposing edge; and
a sealing element extending from the intermediate portion.

2. The weatherseal of claim 1, wherein the sealing element comprises at least one of a pile material, a foam profile, and a hollow bulb.

3. The weatherseal of claim 1, wherein the substantially continuous projection is secured to and projects from each of the first edge and the second opposing edge.

4. The weatherseal of claim 1, wherein the base comprises a material comprising a first stiffness and the projection comprises a material comprising a second stiffness that is less than the first stiffness.

5. The weatherseal of claim 1, wherein the substantially continuous projection comprises a material having a Rockwell Shore A hardness less than about 80.

6. The weatherseal of claim 5, wherein the substantially continuous projection comprises a material having a Rockwell Shore A hardness less than about 40.

7. The weatherseal of claim 1, wherein the substantially continuous projection comprises at least one material selected from the group consisting of thermoplastic elastomers, flexible polyvinyl chloride, and ethylene vinyl acetate.

8. The weatherseal of claim 1, wherein the base comprises a material having a Rockwell Shore D hardness greater than about 20.

9. The weatherseal of claim 8, wherein the base comprises a material having a Rockwell Shore D hardness greater than about 60.

10. The weatherseal of claim 1, wherein the base comprises at least one material selected from the group consisting of polypropylene, rigid polyvinyl chloride, and acrylonitrile butadiene styrene.

11. A method for manufacturing a weatherseal, the method comprising the steps of:
providing a T-shaped base comprising a first edge, a second opposing edge, and an intermediate portion between the first edge and the second opposing edge; and
extruding a substantially continuous projection onto at least one of the first edge and the second opposing edge.

12. The method of claim 11, wherein the substantially continuous projection is secured to and projects from each of the first edge and the second opposing edge.

13. The method of claim 11, further comprising the step of providing a sealing element extending from the intermediate portion.

14. The method of claim 13, wherein the sealing element is extruded onto the intermediate portion.

15. The method of claim 11, wherein the base providing step comprises extruding the base and wherein the projection extruding step comprises co-extruding the projection with the base.

16. The method of claim 11, wherein the base comprises a material comprising a first stiffness and the projection comprises a material comprising a second stiffness that is less than the first stiffness.

17. A fenestration frame comprising:
a frame member defining a substantially T-shaped slot; and
a weatherseal comprising:
a T-shaped base comprising a first edge, a second opposing edge, and an intermediate portion between the first edge and the second opposing edge, wherein the base is located substantially within the T-shaped slot;
a sealing element extending from the intermediate portion; and
a substantially continuous projection secured to and projecting from at least one of the first edge and the second opposing edge.

18. The fenestration frame of claim 17, wherein the weatherseal defines a weatherseal width.

19. The fenestration frame of claim 18, wherein the T-shaped slot comprises a nominal width substantially equal to or less than the weatherseal width to promote a close fit or an interference fit.

20. The fenestration frame of claim 17, wherein the sealing element comprises a sealing element width proximate the intermediate portion.

21. The fenestration frame of claim 20, wherein the T-shaped slot comprises a throat width larger than the sealing element width.

22. The fenestration frame of claim 17, wherein the substantially continuous projection is secured to and projects from the first edge and the second opposing edge.

23. A method for inserting a weatherseal into a frame member defining a substantially T-shaped slot with a throat opening, the method comprising the steps of:
providing a weatherseal comprising:
a T-shaped base comprising a first edge, a second opposing edge, and an intermediate portion between the first edge and the second opposing edge,
a sealing element extending from the intermediate portion, and
a substantially continuous projection secured to and projecting from at least one of the first edge and the second opposing edge;
inserting the first edge into the T-shaped slot at an angle through the throat opening; and
forcing the second opposing edge into the T-shaped slot through the throat opening.

24. The method of claim 23, wherein the forcing step utilizes at least one of a roller and an insertion finger.
